(19) United States
(12) Patent Application Publication
(10) Pub. No.: US 2005/0181667 A1
(43) Pub. Date: Aug. 18, 2005

(54) Dual-purpose RCA plug structure

(76) Inventor: Ta-San Kao, Yun Lin Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/778,138

(22) Filed: Feb. 17, 2004

(51) Int. Cl. H01R 9/05

(52) U.S. Cl. 439/578

(57) ABSTRACT

A dual-purpose RCA plug structure includes: a base connecting a housing; the base is a hollow cylinder having an end being extended therein with a coaxial needle core having thereover an insulation envelopment, and having another end connecting with a wire connecting seat being grounded, the structure is characterized in that: the needle core has on its end an outer thread for movable connecting of a guide post having on its end a screw hole, the diameter of the guide post is larger than that of the needle core. Thereby, the plug has two functions: when the needle core of the small diameter connects the socket having a small hole, characteristic impedance of 75 Ω can surely be obtained to maintain signal transmission without distortion; when the needle core of the small diameter is connected with the guide post with a large diameter, it can afford inserting connection of a conventional socket with a large hole.

### BACKGROUND OF THE INVENTION

1. Field of the Invention

The present invention is related to a dual-purpose RCA plug structure, and especially to a plug structure with a needle core of a small diameter that can make connection with a socket having a small hole and maintain signal transmission without distortion, the needle core of a small diameter can also make connection with a guide post with a large diameter for inserting connection of a conventional socket having a large hole. The structure is applicable to an audio and video unit for converting of audio, video and digital signals.

2. Description of the Prior Art

With advancing of the time, standard of life is relatively elevated, requirements of people for audio and video units for amusement are more and more exquisite, such as for the quality of sound of a hi-fi set, the color of a television set and the degree of analyzing of a picture etc. Therefore, in addition to the audio and video units themselves are required for good quality, signal lines and signal converters for transmitting also take quite important roles.

Generally, digital audio interfaces are divided into optical fibers and RCA coaxial digital lines; coaxial lines sold in the markets presently all use RCA plugs, by the fact that RCA initially designed for transmitting audio signals, RCA plugs are less suitable to transmit digital signals, its characteristic impedance is unable to match, and it thus has bad affection to digital outputting.

As shown in FIG. 1, a general audio and video unit uses an RCA plug “a” for coaxial outputting and inputting; the RCA plug “a” has its anode and cathode separated with an insulating separation layer “b” as a separating medium. A core post of the RCA plug “a” is made coarser in favor of insertion and extracting and being advantageous in not being subjected to bending and deforming, but this renders the characteristic impedance of the RCA plug “a” unable of reaching 75 Ω, and thereby the characteristic impedances of the two ends respectively of the RCA plug “a” and a digital signal-input/output socket “d” can not really match with each other, this will make the quality of digital signal transmitting be lowered. By the fact that every audio and video unit in the markets uses an RCA plug with a large hole, wire connecting of a conventional audio and video unit is unable to meet the requirement of transmitting of digital signals with characteristic impedance of 75 Ω.

In view of these, the present invention was developed to overcome the above defects, to make an RCA plug maintain its characteristic impedance of 75 Ω during insertion connecting of it with a socket, to thereby get the best matching impedance thereof without resulting signal distortion in transmitting.

### SUMMARY OF THE INVENTION

The primary object of the present invention is to provide a dual-purpose RCA plug structure, in which a needle core of a small diameter is connected with a socket having a small hole to really get characteristic impedance of 75 Ω, this can maintain signal transmission without distortion, the needle core of a small diameter can also make connection with a guide post with a large diameter for inserting connection with a conventional socket with a large hole.

To achieve the above stated object, the dual-purpose RCA plug structure provided in the present invention includes: a base in connecting with a housing; the base is a hollow cylinder having an end being extended therein with a coaxial needle core having thereover an insulation envelopment, and having another end connecting with a wire connecting seat being grounded, the structure is characterized in that: the needle core has on its end an outer thread for movable connecting of a guide post having on one end thereof a screw hole, the diameter of the guide post is larger than that of the needle core. Thereby, the plug composed has two functions: when the needle core of the small diameter is connected with the socket having the small hole, a characteristic impedance of 75 Ω can surely be obtained, this can maintain signal transmission without distortion; when the needle core of the small diameter is connected with the guide post with a large diameter, it can afford inserting connection of a conventional socket with a large hole.

The present invention will be apparent after reading the detailed description of the preferred embodiment thereof in reference to the accompanying drawings.

### BRIEF DESCRIPTION OF THE DRAWINGS

FIG. 1 is an analytical perspective view showing the structure of a conventional RCA plug and a socket;

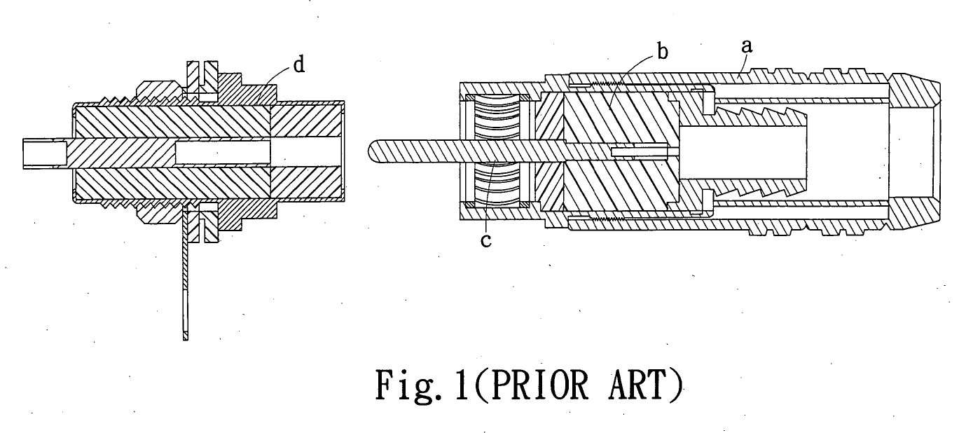

FIG. 2 is a perspective view showing the appearance of a dual-purpose RCA plug structure of the present invention;

FIG. 3 is an analytical perspective view showing the structure of the dual-purpose RCA plug structure of the present invention;

FIG. 4 is a sectional view of the dual-purpose RCA plug structure of the present invention;

FIG. 5 is a schematic sectional view showing the state of using a thinner needle core of the present invention for connecting;

FIG. 6 is a schematic sectional view showing the state of using a coarser needle core of the present invention for connecting;

FIG. 7 shows another embodiment of the present invention.

### DETAILED DESCRIPTION OF THE PREFERRED EMBODIMENT

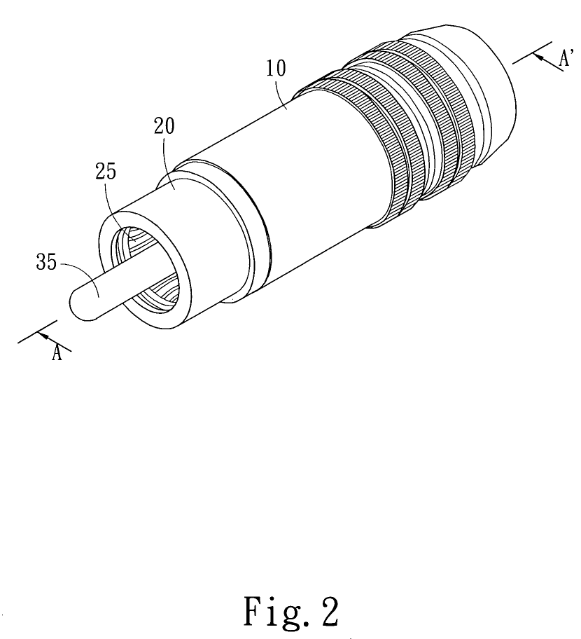

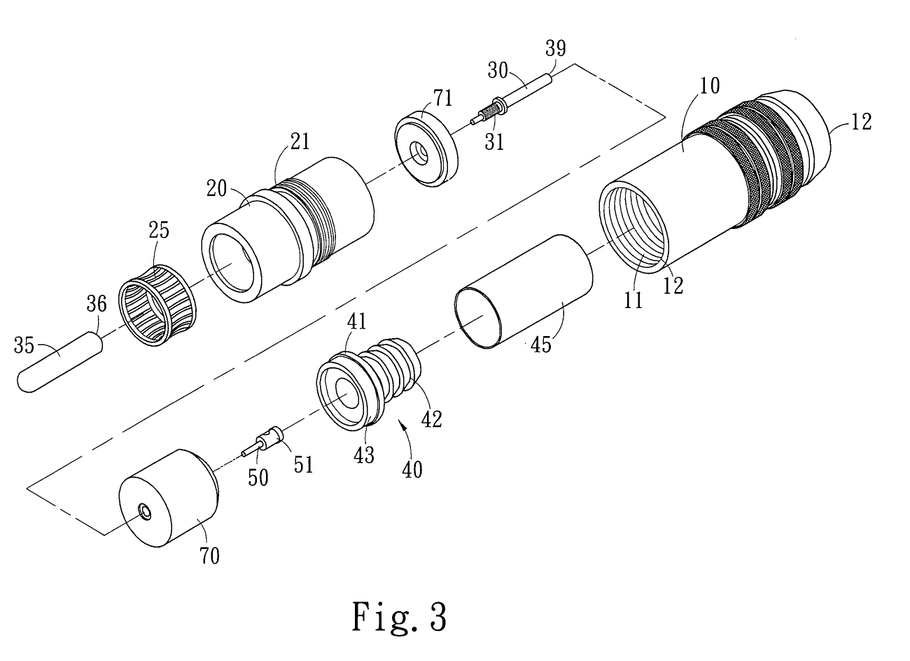

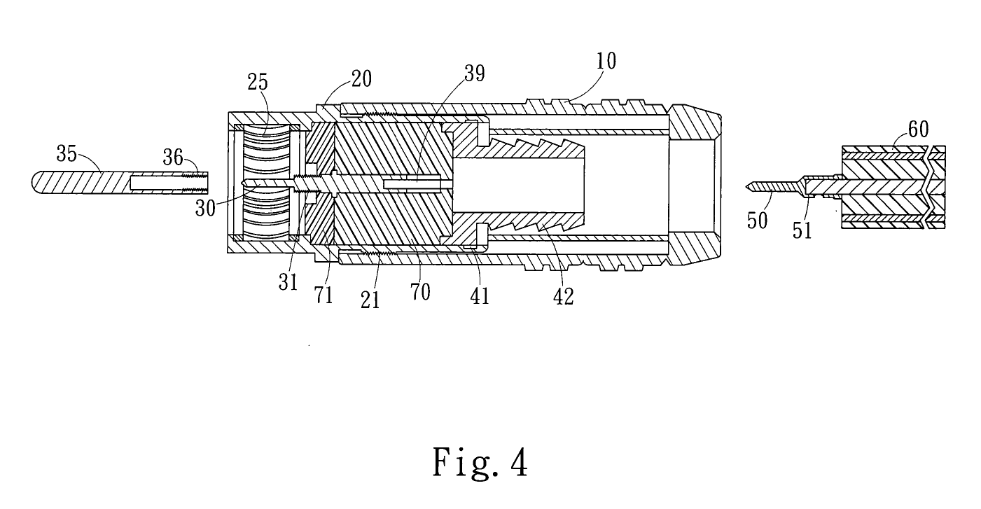

Referring to FIGS. 2-6, the dual-purpose RCA plug structure of the present invention mainly comprises: a base 20 in connecting with a housing 10; the base 20 is a hollow cylinder having an end being extended therein with a coaxial needle core 30, and having another end connecting with a wire connecting seat 40 being grounded, the structure is characterized in that: the needle core 30 has on its rear section a hole 39 connectable with a conductive needle 50, the read end of the conductive needle 50 has a wire receiving barrel 51 provided for welding of the core of a coaxial transmission wire 60; the needle core 30 has on one end thereof an outer thread 31 for movable connecting of a guide post 35 having on one end thereof a screw hole 36, the diameter of the guide post 35 is larger than that of the needle core 30 for suiting inserting connection of a conventional RCA socket.

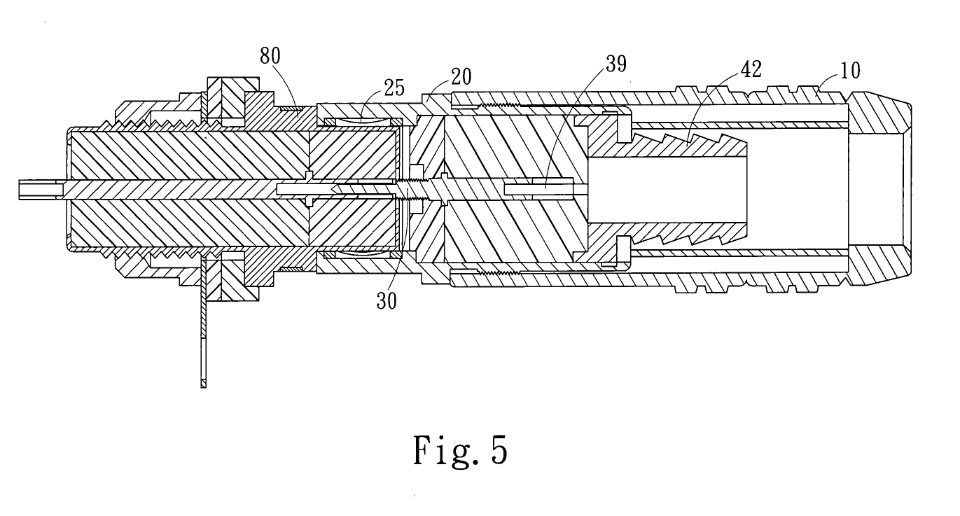

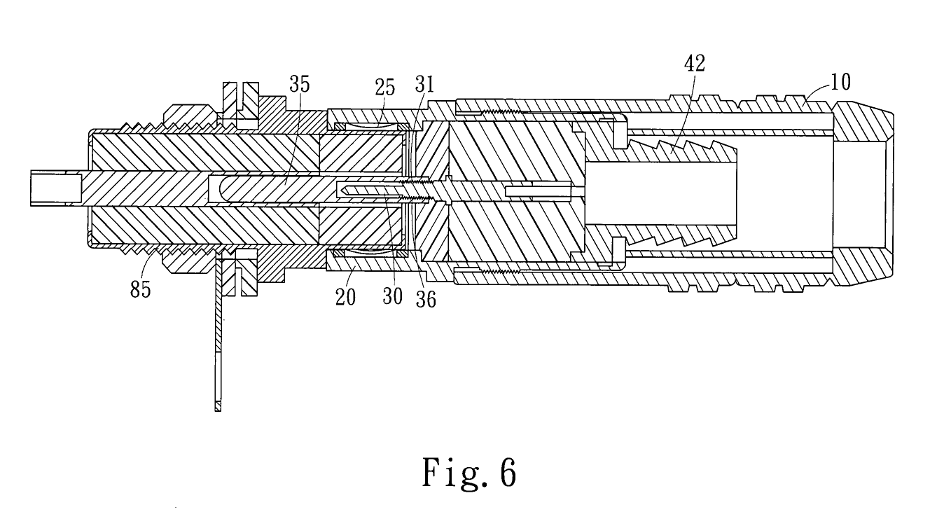

Thereby, as shown in FIGS. 5, 6, the plug composed has two functions: when the needle core 30 of the small diameter is connected with a socket 80 having a small hole specific for characteristic impedance of 75 Ω, it can assure impedance matching in connecting and can maintain signal transmission without distortion; when the needle core 30 of the small diameter is connected with the guide post 35 with a large diameter, it can afford inserting connection of a conventional RCA socket 85 with a large hole.

As shown in FIGS. 2-6, when in practicing, the base 20 has on its surface a thread 21; the housing 10 has on its two ends openings 12, wherein one end has on the inner periphery thereof a thread 11 for screw connecting with the base 20, while the opening 12 on the other end thereof is provided for extending out of the transmission wire 60.

The wire connecting seat 40 has a disk-like member 41 having thereon a hollow protruding toothed post 42 extending centrally and axially for insertion connecting of the transmission wire 60, and a wire binding cylinder 45 is used to clamp firm the transmission wire 60. The disk-like member 41 has thereon a flange 43 to abut against the base 20, an insulation member 70 and an insulation piece 71 both having a central hole are placed in the hollow cylindrical base 20 in front of the disk-like member 41 to serially clamp the needle core 30 and form an insulation envelopment; and the base 20 is provided on the front end thereof with a binding collar 25 for tight binding during abut connecting with a socket 80 or 85.

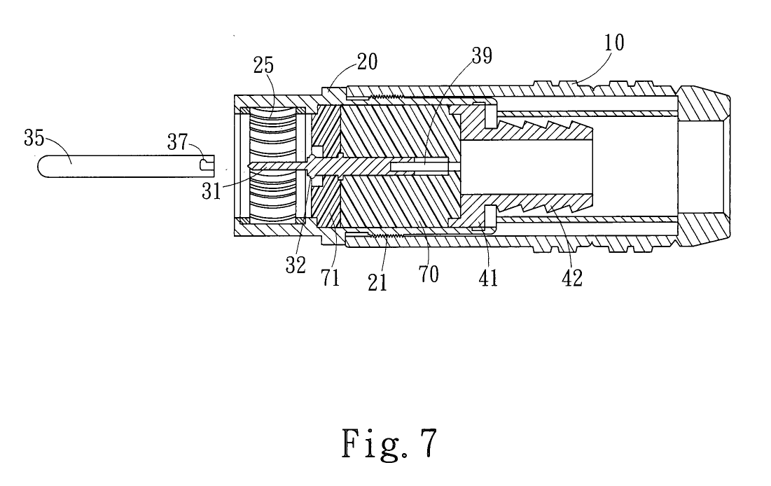

And referring to FIG. 7, in practicing the present invention, the outer thread 31 on one end of the needle core 30 can be substituted by two protrusions 32, and the guide post 35 has on the inner wall of its one end with the screw hole 36 an L shaped groove 37, thereby the embodiment can also get a practicable object of movably assembling and dismantling.

According to the above statement, the dual-purpose RCA plug structure of the present invention is well designed and has the following advantages in use:
1. When the plug uses a thinner needle core which is insertion connected to an RCA socket, it can maintain its characteristic impedance of 75 Ω to assure the best matching during signal transmission without distortion and to meet the practicable requirement of high signal transmitting quality.
2. When the needle core of a small diameter is connected with a guide post with a large diameter, it can afford inserting connection of a conventional socket with a large hole, so that a new fashioned plug can be widely used on various sockets on conventional units.

The above stated is only for illustrating embodiments of the present invention, and not for giving any limitation to the scope of the present invention; it will be apparent to those skilled in this art that various modifications or changes without departing from the spirit of this invention shall also fall within the scope of the appended claims.

In conclusion, according to the description disclosed above, the present invention surely can achieve the expected object thereof to provide a dual-purpose RCA plug structure.

1-5. (canceled)

6. A dual-purpose RCA plug structure for use with a socket, the dual-purpose RCA plug structure comprising:
a) a housing;
b) a coaxial needle core;
c) a base connected to the housing, the base is a hollow cylinder having the coaxial needle core located in a center of a first end thereof and a wire connecting seat located connected to a second end thereof, the wire connecting seat is grounded;
d) an insulation envelop is located between the coaxial needle core and the base; and
e) a guide post removably connected to a first end of the coaxial needle core and protruding from the first end of the base, an outer diameter of the guide post is larger than an outer diameter of the coaxial needle core,
wherein, when the coaxial needle core is connected with the socket, a characteristic impedance of 75 Ω is obtained maintaining an undistorted signal transmission.

7. The dual-purpose RCA plug structure according to claim 6, wherein the housing is threadedly connected to the base at a first end thereof and having a transmission wire extending from a second end thereof.

8. The dual-purpose RCA plug structure according to claim 6, further comprising a wire binding cylinder located within the housing and clamping a transmission wire.

9. The dual-purpose RCA plug structure according to claim 6, wherein the wire connecting seat having:
a) a disc member located on an outer periphery thereof;
b) a flange located on a first end thereof and engaging the base; and
c) a hollow protruding toothed part extending from a second end thereof and connected to the transmission wire.

10. The dual-purpose RCA plug structure according to claim 6, wherein the insulation envelop includes an insulation member and an insulation piece serially clamping the coaxial needle core.

11. The dual-purpose RCA plug structure according to claim 6, further comprising a binding collar located in the first end of the base selectively engaging the socket.

12. The dual-purpose RCA plug structure according to claim 6, further comprising a conductive needle connected to a transmission wire, the coaxial needle core having a hole located on a second end thereof, the conductive needle being removably inserted into the hole.

13. The dual-purpose RCA plug structure according to claim 12, wherein the conductive needle having a wire receiving barrel welded to a core of the transmission wire.

14. The dual-purpose RCA plug structure according to claim 6, wherein the coaxial needle core having two protrusions located on an outer periphery, the guide post having an L-shaped groove located on opposing sides of an interior wall thereof, one of the two protrusions engaging each L-shaped groove and connecting the guide post to the coaxial needle core.

15. The dual-purpose RCA plug structure according to claim 6, wherein the coaxial needle core and the guide post are threadedly connected.
